(19) United States
(12) Patent Application Publication
(10) Pub. No.: US 2008/0275681 A1
(43) Pub. Date: Nov. 6, 2008

(54) Method and system for vehicle damper system evaluation and tuning with loading system and vehicle model

(76) Inventor: William J. Langer, Minnestrista, MN (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/800,412

(22) Filed: May 4, 2007

(51) Int. Cl. G01M 17/04; G06G 7/48

(52) U.S. Cl. 703/8; 702/41; 73/11.04

(57) ABSTRACT

A method and system for evaluating and tuning damper system includes at least one test rig on which one or more physical damper system are mounted. A full vehicle model and a road description are used with the test rig to test and evaluate or tune the damper system as would be conducted on a real test track. The full vehicle model is modified to remove the characteristics of the damper system under test. The remainder of the full vehicle model produces output signals in the form of displacements or loads that are transmitted as inputs to the test rig to apply those signals. The test rig measures output signals in the form of complementary displacements or loads that will become inputs to the vehicle model in place of the removed model of the damper system under test. In this manner, the physical damper system under test is inserted into a real time model of the full vehicle, road and driver.

### FIELD OF DISCLOSURE

This application generally relates to vehicle suspension testing and evaluations, and more specifically, to methods and systems for testing and tuning suspension components, specifically damper systems, and determining their effect on vehicle performance, or the effect of the vehicle on the component.

### BACKGROUND

For the purpose of this document, the terms “damper” and “damper system” shall refer to the system of suspension components that dissipate or absorb energy. The damper systems may include some or all of the following: dampers, struts, coil-over dampers or struts, jounce bumpers, springs, bushings, mounts, electronic controllers, sensors, and/or actuators.

The term “suspension” usually refers to the system of springs, dampers and linkages that connects a vehicle to its wheels. Suspension systems serve a dual purpose—contributing to the car's body position, handling, braking and driving pleasure, and keeping vehicle occupants comfortable and reasonably well isolated from road noise, bumps, and vibrations. The suspension must also satisfy durability, safety, and packaging requirements among other constraints. These goals are generally at odds, so the development, validation, and tuning of suspensions involves finding the right compromises. Damper systems are critical components of suspension design and function. Design of front and rear suspension of a car is typically different.

Traditional springs and dampers are referred to as passive suspensions. If the suspension is externally controlled then it is a semi-active or active suspension. Semi-active suspensions include devices such as air springs and variable valve orifice dampers, various self-leveling solutions, as well as other similar systems.

Active or semi-active suspensions use electronic monitoring of vehicle conditions, coupled with the means to impact vehicle suspension and behavior in real time to directly control the motion of the car.

In general, suspension systems can be broadly classified into two subgroups—dependent and independent. These terms refer to the ability of opposite wheels to move independently of each other. A dependent suspension normally has a live axle (a simple beam or ‘cart’ axle) that holds wheels parallel to each other and perpendicular to the axle. When the camber of one wheel changes, the camber of the opposite wheel changes in the same way. An independent suspension allows wheels to rise and fall on their own without affecting the opposite wheel. Suspensions with other devices, such as anti-roll bars that link the wheels in some way are still classed as independent. A third type is a semi-dependent suspension. In this case, jointed axles are used, on drive wheels, but the wheels are connected with a solid member, most often a deDion axle. This differs from “dependent” mainly in unsprung weight.

Vehicle suspensions, dampers in particular, must be evaluated, tested or tuned to meet desired vehicle-level performance attributes such as handling, ride, comfort, NVH (noise, harshness, vibration), etc. Today, in order to assess vehicle-level attributes, the vehicle must be driven with the real components installed. This method is costly, slow, and non-repeatable. Also, it typically occurs late in the vehicle development process, when the cost of change and rework is high. Further, engineers may desire to assess the impact of a vehicle on a suspension to determine attributes such as performance, durability, transmissiblility, etc.

Damper systems influence vehicle attributes such as ride, comfort and handling. Components, such as dampers and bushings, are characterized in testing equipment, but such testing equipment does not directly relate to, or measure, the vehicle response to the given component. Current testing equipment characterizes suspensions by applying a load or a displacement time history to the suspension components and measuring resultant load or displacements. To demonstrate the challenge, two different dampers, with different in-vehicle performance, might yield the same characterization data when evaluated in conventional test equipment.

In the case of a real vehicle on a test track, the evaluation of suspension effects on vehicle performance can be directly observed and measured. The measurement of vehicle performance then depends only on the ability to measure the necessary effects and the repeatability of the test track process. However, in the case of laboratory test rig evaluation of damper system performance, either measured time histories or idealized time histories are applied to the damper system only. The resulting damper system loads or displacements are reduced to simplified engineering terms such as parameter maps, gradients or frequency response functions. The reduced engineering terms of damper system performance are used to deduce resultant vehicle behavior through a vehicle model or expert interpretation that is applied after the test results are obtained. While track testing provides complete vehicle-level responses, by definition, it requires a complete vehicle and also brings other practical penalties such as vehicle availability, weather and repeatability limitations, and the time-intensive process of damper change-outs.

A limitation in the laboratory test rig evaluation process is that a simplified model is assumed for the damper system. This means that it is possible to use a model that ignores important suspension/component characteristics. This is especially true for those characteristics that may manifest during a transient or dynamic input, be sensitive to temperature or humidity, or be subject to non-linear effects such as friction. Further, the process does not capture changing damper system characteristics. Damper system characteristics that change depending on recent history or hard-to-model parameters such as temperature or friction will not develop or be measured on a laboratory test rig in a manner that accurately predicts vehicle behavior.

Therefore, there is a need to provide a suspension/component development, evaluation, validation, and tuning process and system that does not rely on a simplified model of a suspension/component or a full vehicle. Further, there is a need in such a system to capture suspension/component characteristics and translate the results to vehicle-level attributes.

Further, there is a need to assess the effects of a vehicle on a component without the need for an actual vehicle. In such an evaluation the component would be exposed to realistic vehicle-based inputs, as if in service, to assess the component for durability, NVH, or other attributes. The realistic vehicle inputs could replace the simplified engineering inputs (e.g. sine waves) common in traditional test-rig based methods.

### SUMMARY

This and other needs are met by embodiments of the present invention, which provide a system for evaluating damper systems that comprise a test rig on which at least one damper system is mountable, and a vehicle model module. The test rig controllably applies loads on the damper system component under test. The vehicle model module includes a data processor for processing data, and a data storage device. The data storage device is configured to store: data related to a vehicle model that simulates a full vehicle except for characteristics of the damper system under test; data related to a road description; and machine-readable instructions. Upon execution by the data processor, the instructions control the data processor to produce command signals based on the vehicle model to control the test rig to apply loads on the damper system and to feed back measured responses of the damper system to the vehicle model.

The foregoing and other features, aspects and advantages of the disclosed embodiments will become more apparent from the following detailed description and accompanying drawings.

### BRIEF DESCRIPTION OF THE DRAWINGS

The present disclosure is illustrated by way of example and not by way of limitation, in the figures of the accompanying drawings and in which like reference numerals refer to similar elements.

FIG. 1 depicts a partially perspective, partially block view of a system for damper system evaluation constructed in accordance with certain embodiments of the present invention.

FIG. 2 is a block diagram of the system of FIG. 1, depicting the relationships between components, namely software and electronic components, of the system in more detail.

FIG. 3 is a side view of a portion of the test rig depicted in FIG. 1, constructed in accordance with embodiments of the present invention.

FIG. 4 is a detail of a portion of FIG. 3.

FIG. 5 is a schematic depiction of a tire and strut showing parameters in determining the moment on the strut or other damper system.

FIG. 6 is a block diagram of a data processor system useable in embodiments of the present invention.

### DETAILED DESCRIPTION

For illustration purposes, the following descriptions describe various illustrative embodiments of simulation systems for evaluating or tuning damper systems. Specific systems and configurations of the test rig are depicted. It will be apparent, however, to one skilled in the art that concepts of the disclosure may be practiced or implemented without these specific details. In other instances, well-known structures and devices are shown in block diagram form in order to avoid unnecessarily obscuring the present disclosure. Also, for ease of description, the terms “damper” and “damper system” will be employed interchangeably throughout, in accordance with the definition previously presented. However, it should be understood that for purposes of this description, the embodiments of the invention are applicable to testing and evaluating an entire damper system, or only one or more components of the damper system.

Embodiments of the present invention address and solve problems related to the process of damper testing, characterization, evaluation, model validation, or tuning. For ease of description, the term “evaluation” will be employed to refer to the process of testing, characterization, evaluation, model validation or tuning. These problems are solved, at least in part, by embodiments of the present invention that provide a system for evaluating dampers that comprise at least one test rig on which at least one damper system is mountable, and a vehicle model module. The test rig controllably imposes forces and motions to the damper system under test. The vehicle model module includes a data processor for processing data, and a data storage device. The data storage device is configured to store: data related to a vehicle model that simulates a full vehicle except for characteristics of the damper system present under test; data related to a road description; and machine-readable instructions. Upon execution by the data processor, the instructions control the data processor to produce command signals based on the vehicle model to control the test rig to apply forces and motions to the damper system and to feed back measured responses of the test rig to the vehicle model.

There are numerous potential benefits achieved with embodiments of the present invention. These include allowing damper system testing to occur without the need to gather road data with a full vehicle. This permits earlier testing in the design process than otherwise possible.

Another benefit of the disclosed embodiments is that the test process need not reduce the damper system characteristics to simplified engineering terms of an implied suspension model. This is because the real damper system(s), with all of its un-modeled characteristics, interacts with the modeled vehicle as it would with a real vehicle. Also, because the damper system interacts with the vehicle model through test rig feedbacks, changes in the damper system characteristics will result in changes in applied load, as would happen on a real road. Thus results in more realistic damper evaluation. The effect of the damper system on vehicle behavior is measured directly in the vehicle model, just as the more inconvenient road test measures damper system/vehicle behavior directly.

Further, the effect of the modeled vehicle model on the damper system may be observed or measured directly with sensors on the test rig, just as the effect of the more inconvenient road test allows direct observation or measurement of damper system. It is also possible, with embodiments of the invention, to characterize the damper under conditions which represent those that would occur on the road, without the need for either a real vehicle or a real road, which may not be available at the time of measurement. The resulting characterization can be more representative than prior characterizations based on more traditional synthetic inputs, such as sinusoidal inputs.

Another benefit is that time consuming load history iteration compensations are rendered unnecessary by certain embodiments of the invention due to minimum tracking error characteristics of the test rig. Also, the set of all possible damper systems can be reduced to a smaller set for in-vehicle analysis reducing track testing cost and time.

Another benefit is the ability to isolate the physical components of the damper system to only those which are of interest for the test. This is, of course, not possible for evaluation conducted on the test track where most, if not all, of the vehicle is required in order to conduct tests.

The ability to perform suspension evaluation and tuning earlier in the design process avoids late cycle changes and impacts to dependent vehicle characteristics such as NVH, durability, etc. Also, the embodiments of the invention provide the ability to assess damper system design and manufacturing changes on the parameters of the vehicle without needing an actual full vehicle. This allows performance of evaluations, often at an earlier stage and at less cost, of durability, performance, safety, NVH and other evaluations without requiring a full vehicle. The embodiments of the invention also provide the ability to more accurately induce and capture the effects of damper system component wear.

An automobile includes various subsystems for performing different functions such as power train, driver interface, climate and entertainment, network and interface, lighting, safety, engine, braking, steering, chassis, etc. Each subsystem further includes components, parts and other subsystems. For instance, a power train subsystem may include a transmission controller, a transmission, a transfer case, an all wheel drive (AWD) system, an electronic stability control system (ESC), a traction control system (TCS), etc. A chassis subsystem may include active or passive dampers, springs, bushings, body control actuators, anti-roll bars, etc. Designs and durability of these subsystems need to be tested and verified during the design and manufacturing process. Some of the subsystems use electronic control units (ECU) that actively monitor the driving condition of a vehicle and dynamically adjust the operations and/or characters of the subsystems, to provide better control or comfort. Models used for vehicle evaluation must in some way include all relevant subsystems.

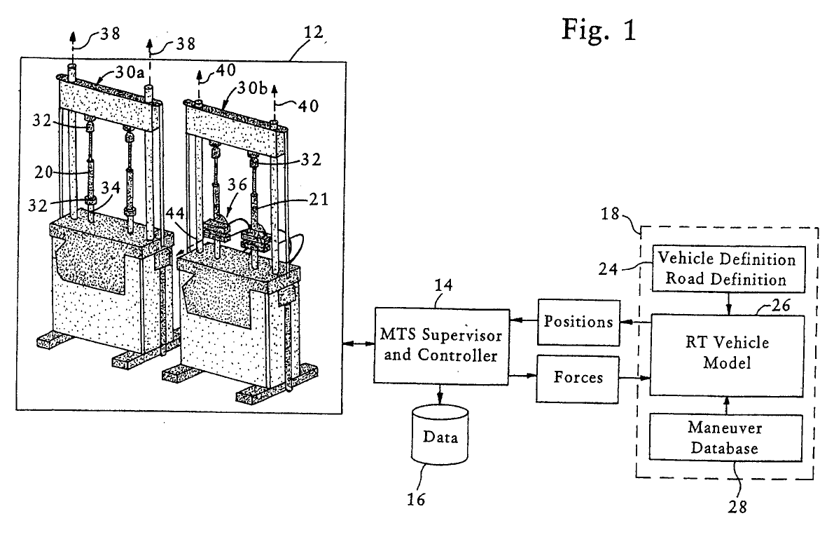

Certain embodiments of the present invention provide methods and systems to perform damper system testing, evaluation or tuning by combining a full vehicle model, a road description and at least one test rig on which is mounted one or more physical damper systems. An exemplary embodiment of such a system 10 is depicted in FIG. 1.

The system 10 includes at least one test rig 12, a supervisor and controller (hereafter “supervisor”) 14, a data storage device 16, and a vehicle model module 18, including environment and maneuver definitions. In certain described exemplary embodiments, the vehicle model module 18 is implemented on a data processor that is separate from the data processor implementing the supervisor 14. In other exemplary embodiments, the supervisor 14 and vehicle model module 18 are realized by a single data processor.

The configuration of the test rig 12 depicted in FIG. 1 is exemplary only, as other configurations and types of test rigs may be used without departing from the scope of the invention. The exemplary test rig 12 allows one or more damper systems to be mounted for evaluation. In the illustrated example, the suspension components are dampers 20 and struts 21 that are mounted in a manner that allows displacements or loads to be applied and resultant displacements or loads to be measured.

Among other options, various environmental effects can be simulated. For example, the test rig 12, or damper system 20, may be located in a climate chamber (not shown) to control and/or capture the effects of heat, cold, humidity, moisture, dirt, salt or other environmental factors.

Different environment and roadway surface conditions may be simulated in software. The road surface can be defined in a software model or measured and translated to software code, in different embodiments of the invention. The road definition can include such parameters as coefficient of friction, roughness, slope, curvature, bump or obstacle profiles, and temperature. The environment simulation may include influences on the vehicle such as wind and air.

The test rig 12 depicted in FIG. 1 includes two test stands 30a, 30b, in which the dampers 20 and struts 21 are respectively mounted for testing. The dampers 20 in test stand 30a are held at the top and bottom by holders 32. Test rigs 30a and 30b include a load and/or displacement measurement sensor(s). Loading actuators 34 provide controllable loads and displacements to the dampers 20. The loading actuators 34 are independently controllable to apply independent vertical loads and/or other linear degrees of freedom along vertical axes 38.

The struts 21 in test stand 30b are held at the top by holders 32, but are held at the bottom by moment input fixtures 36 that are mounted on loading actuators 34. The loading actuators 34 are independently controllable to apply independent vertical loads and/or other linear degrees of freedom along vertical axes 40, while the moment input fixtures 36 are independently controllable to inject a moment on the struts 21 in the direction of arrow 42 around a horizontal axis 44. The simulated moments result from in-vehicle installation geometry, such as McPherson struts, to capture effects such as moment-induced friction and stiction. The use of moment input fixtures 36 is exemplary only, as other configurations for applying loads and displacements may be employed without departing from the scope of the invention.

Dampers 20 and struts 21 may or may not be mounted with springs to capture the effects of off-damper-axis loads. Similarly, dampers 20 and struts 21 may be mounted with or without in-vehicle mounting brackets, top or bottom bushings, or any other in-vehicle components of interest.

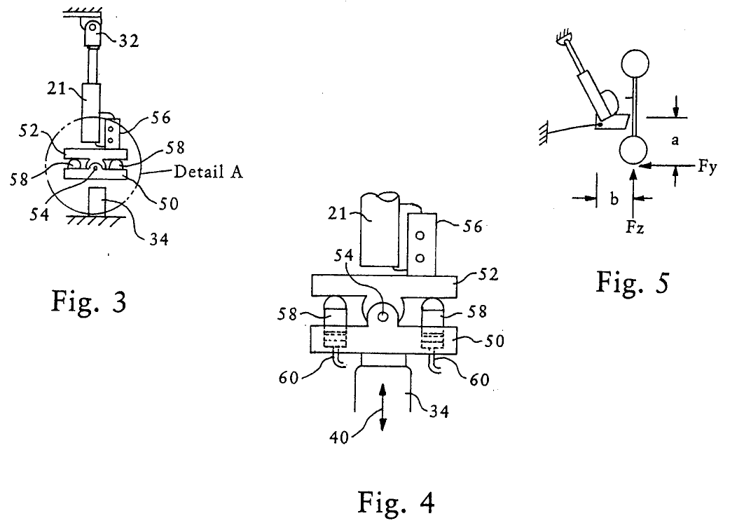

An exemplary embodiment of the moment input fixtures is depicted in FIGS. 3 and 4. The moment input fixture 36 is mounted by a bottom plate 50 on the loading actuator 34 and therefore is vertically displaceable along axis 40. A mounting plate 52 is mounted to the bottom plate 50 at pivot 54. The mounting plate 52 can be pivoted around the horizontal axis defined by the pivot 54. An adaptor 56 mounts the strut 21 to the mounting plate 52.

A pair of pistons 58 are provided on the bottom plate 50. Each piston 58 is coupled, through ports 60 to a servovalve that controls pressure to the pistons 58. The pistons 58 act on the mounting plate 52 to control the pivoting of the mounting plate 52 around the pivot 54. The pivoting of the mounting plate 52 produces a moment on the strut 21. The moment at the base of a strut is defined as Mx=Fy(a)−Fz(b), see FIG. 5. The moment input fixture 36 applies a moment to the strut 21 as calculated from the real time full vehicle model 26 which determines the necessary values of Fy, Fz, a, b so that the moment on the strut 21 should correspond to the moment Mx when driven as in the vehicle model 26. The moment input devices in FIGS. 3 and 4 may be substituted with other configurations, using different energy sources, to perform the same loading function.

The loading actuators 34 control forces in the Z direction, and the moment input fixtures 36 control moment inputs around the horizontal axis. The positioning of the suspension components, i.e., the dampers 20 and the struts 21, are provided by the vehicle model module 18 to the supervisor 14. In turn, the supervisor 14 issues command signals to the test rig 12 to control the loading actuators 34 and moment input fixtures 36 according to the positions or loads provided by the vehicle model module 18. Load cells and/or position sensors (not shown) are provided, with signals indicating load measurements from the load cell representing measured forces and moments being provided back to the vehicle model 26 through the supervisor 14. For example, the embodiments of the invention are able to measure damper system responses.

As stated earlier, embodiments of the invention perform damper system testing, characterization, model validation, evaluation or tuning by combining a full vehicle model, a road description and a test rig on which is mounted one or more physical damper system components. To this end, a vehicle definition and road definition 24 are provided as inputs to a vehicle model 26 of the vehicle model module 18. A maneuver database 28 is also provided as an input to the vehicle model 26. Driver maneuvers, time histories, or mathematical functions, are defined to excite required vehicle metrics that are influenced by damper systems.

The output of the vehicle model 26, positions for example, are to be applied to the damper components, such as dampers 20 and struts 21. The supervisor 14 generates command signals based on this information to control the test rig 12, including, for example, the loading actuators 34 and the moment input fixtures 36. The supervisor 14 provides measurements, such as forces and moments, received from the test rig 12 and inputs these into the vehicle model 26. The forces and moments can be measured at the test rig 12 by any suitable devices, such as load cells provided on different axes.

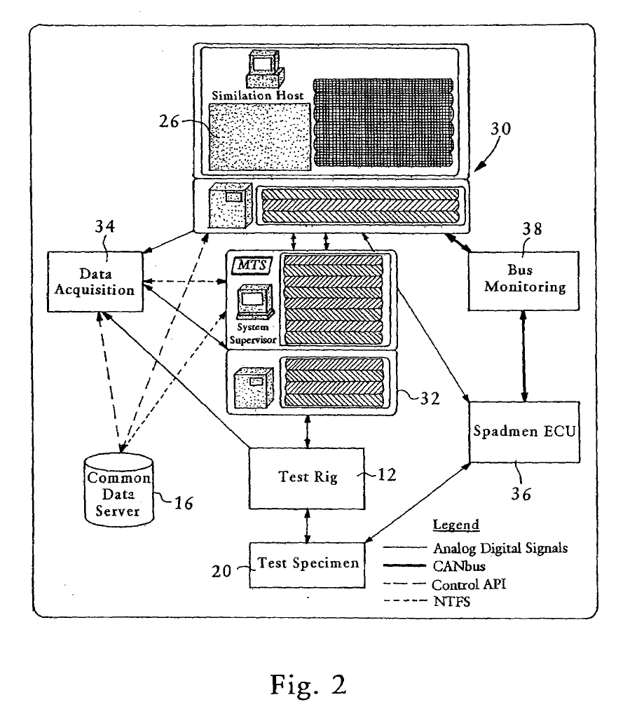

Embodiments of the invention combine a full vehicle model, a road description and a test rig with the physical suspension. Modeling techniques are widely used and known to people skilled in the art. Companies supplying tools for building simulation models include Tesis, dSPACE, Mechanical Simulation Corporation, and The MathWorks. Companies that provide HIL include dSPACE, ETAS, Opal RT, A&D, etc. The full vehicle model 26 is executed in real time, in certain embodiments, by a separate data processor 30, as seen in FIG. 2. The full vehicle model 26 may include the following vehicle functions executed in real time: engine, powertrain, tires, vehicle dynamics, suspensions, aerodynamics, driver, road. As stated earlier, at least one physical damper system component is used in the testing, and this suspension component is not in the model. Other damper system components are modeled if they are not physically present on the test rig 12. Hence, only a single physical damper system, such as a damper 20 or strut 21 may be tested, with the other suspension components modeled in the full vehicle model 26. Alternatively, a convergence method is used in certain embodiments to determine suspension effects on vehicle performance if damper systems from the other corners of the vehicle are not physically present based on iterative readings from the damper systems 20 that are physically present. The present damper system is swapped by the software to various positions on the virtual vehicle in the full vehicle model 26. Iterative techniques are used to converge on a solution within defined error limits by using the real damper system data or the simulation solution to populate suspension models or determine vehicle response.

The context of the model is one which predicts the motion of the vehicle over the ground, given a driver's input of steering, throttle, brake and gear, as well as external disturbances such as aerodynamic forces. The model can be operated open loop with respect to the driver replicating driver's inputs versus time. The model can be operated closed loop with respect to the driver if the driver's inputs are adjusted to maintain a speed and course of the vehicle.

The full vehicle model 26 is modified, as mentioned earlier, to remove the characteristic of the damper system components under test. The remainder of the full vehicle model 26 is provided with the output signal described above, in the form of displacements or loads, which are transmitted as input signals to the test rig 12 to apply those same signals. The test rig 12 measures output signals in the form of complementary displacements or loads that become physical inputs to the full vehicle model 26 in place of the removed model of the suspension component or components under test. In this way, the physical damper system components under test are inserted into a real time model 26 of the full vehicle, road and driver.

Embodiments of the testing method of the present invention are conducted as on a real test track with either an open loop or closed loop driver. The test rig 12, working with the full vehicle model 26, applies loads to the damper system components in a manner that will be similar to the loads developed on a real road. The test rig 12 commands are not known in advance, so test rig iterative control techniques to develop modified load time histories may not be used. The test rig control is designed to produce minimum command tracking error. System identification techniques achieve minimum tracking error.

In certain embodiments, other physical suspension components are provided. For example, spring/coil assemblies may be provided to capture damper moments and other spring effects. A jounce bumper may also be included and tested in certain embodiments, and upper and lower damper bushings in still other embodiments. A damper or strut mount may also be included in certain embodiments.

FIGS. 1 and 2 depict only a single test rig 12 for testing damper systems. In other embodiments of the invention (not shown), other component test rigs, such as tires, steering, etc., are linked to the damper system via the real-time model and supervisor to assess multiple mechanical and/or electronic and software systems in real time.

Referring to FIG. 2, the supervisor 14 is depicted as being provided by a second data processor 32, although the data processors 30 and 32 may be realized by a single data processor in certain embodiments. The software run by the data processor 32 coordinates the full vehicle model run by the data processor 30, the HIL (hardware in loop) system (if present) and the test rig 12. The system may provide an automation method/sequence that can vary vehicle, component control software, driver model, or maneuver definitions to find faults or search for local/global optimum settings as defined by a list of target attributes. In certain embodiments, the full vehicle model 26 integrates with and simulates a vehicle electronics network. The suspension or vehicle (electronic control units) ECUs may be included with or without HIL ECU test system to provide ECU vehicle parameters required to simulate in-vehicle operation.

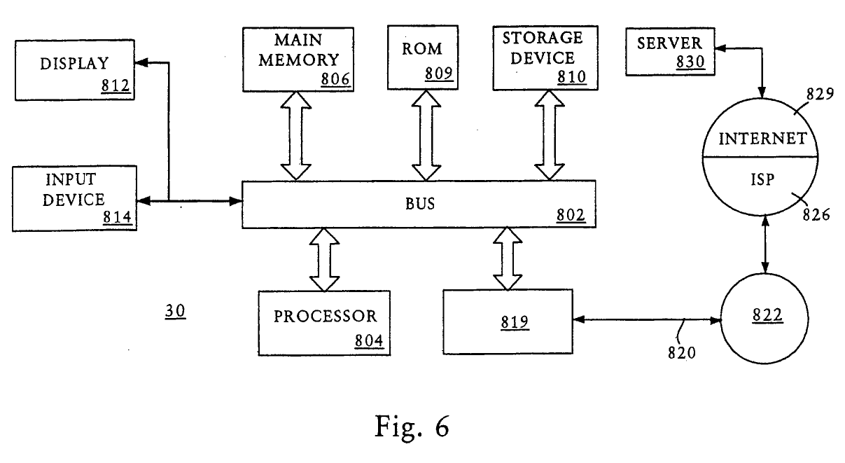

A more detailed description of an exemplary embodiment of a suitable data processor (30 or 32) is provided in FIG. 6, but FIG. 2 provides an overall view of the arrangement 10 and will be described. The simulation model 26 is run by the vehicle control module 18, which may be embodied, at least in part, by the data processor 30. In certain embodiments, the data processor 30 includes a plurality of modules for running the vehicle model. These include, for example, model optimization and mapping, customer simulation models, code generation, runtime tools and simulation visualization. The data processor performs real-time execution of simulation models, and includes a signal and communication interface.

The supervisor 14, embodied by the data processor 32, for example, also has a plurality of modules. These include rig system initialization, system setup, manual control, automated sequencing, subsystem management, system status, rig visualization, rig calibration, real-time degree of freedom control, data acquisition, signal management and safety management.

Data acquisition controller 34 acquires data signals from the test rig 12, and provides them to the data processor 32 of the supervisor 14. The data signals are produced by the load cells (not shown). The data is output by the supervisor 14 to the data processor 30 for use in the vehicle model 26.

An electronic control unit (ECU) 36 can be part of the evaluation process in certain embodiments, and be removed from the vehicle model 26, as is the case for the damper systems 20. The ECU 36 under test may be part of an active suspension system, for example, or some other system. Bus monitoring may be performed by a bus monitor 38.

Methods of the present invention reduce real-time test rig control lag, and compensate for test rig sensors as necessary. Sensor signals are communicated to the vehicle model with minimal lag to permit stable operation of the model. Data from the full vehicle model 26 can be captured and stored to serve as experimental results. Similarly, data from the suspension components can be captured and stored to serve as experimental results.

FIG. 6 is a block diagram that illustrates an exemplary embodiment of the data processing system 30 upon which a real-time full vehicle simulation model 26 may be implemented by the vehicle model module 18. A similar data processing system may be employed for the data processing system comprising the supervisor 14. Data processing system 30 includes a bus 802 or other communication mechanism for communicating information, and a processor 804 coupled with bus 802 for processing information. Data processing system 30 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Data processing system 30 further includes a read only memory (ROM) 809 or other static storage device coupled to bus 802 for storing static information and instructions for processor 804. A storage device 810, such as a magnetic disk or optical disk, is provided and coupled to bus 802 for storing information and instructions. In certain embodiments, the data storage device 810 comprises the storage device 16.

Data processing system 30 may be coupled via bus 802 to a display 812, such as a cathode ray tube (CRT), for displaying information to an operator. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812.

The data processing system 30 is controlled in response to processor 804 executing one or more sequences of one or more instructions contained in main memory 806. Such instructions may be read into main memory 806 from another machine-readable medium, such as storage device 810 (16). Execution of the sequences of instructions contained in main memory 806 causes processor 804 to perform the process steps described herein. In alternative embodiments, hard-wired circuitry may be used in place of or in combination with software instructions to implement the disclosure. Thus, embodiments of the disclosure are not limited to any specific combination of hardware circuitry and software.

The term “machine readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810 (16). Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 804 for execution. For example, the instructions may initially be carried on a magnetic disk of a remote data processing system. The remote data processing system can load the instructions into its dynamic memory and send the instructions over a telephone line using a modem. A modem local to data processing system 30 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 (16) either before or after execution by processor 804.

Data processing system 30 also includes a communication interface 819 coupled to bus 802. Communication interface 819 provides a two-way data communication coupling to a network link that is connected to a local network 822. For example, communication interface 819 may be an integrated services digital network (ISDN) card or a modem to provide a data communication connection to a corresponding type of telephone line. As another example, communication interface 819 may be a local area network (LAN) card to provide a data communication connection to a compatible LAN. Wireless links may also be implemented. In any such implementation, communication interface 819 sends and receives electrical, electromagnetic or optical signals that carry digital data streams representing various types of information.

The network link 820 typically provides data communication through one or more networks to other data devices. For example, the network link 820 may provide a connection through local network 822 to a host data processing system or to data equipment operated by an Internet Service Provider (ISP) 826. ISP 826 in turn provides data communication services through the world wide packet data communication network now commonly referred to as the “Internet” 829. Local network 822 and Internet 829 both use electrical, electromagnetic or optical signals that carry digital data streams. The signals through the various networks and the signals on network link 820 and through communication interface 819, which carry the digital data to and from data processing system 30, are exemplary forms of carrier waves transporting the information.

Data processing system 30 can send messages and receive data, including program code, through the network(s), network link 820 and communication interface 819. In the Internet example, a server 830 might transmit a requested code for an application program through Internet 829, ISP 826, local network 822 and communication interface 819.

The data processing also has various signal input/output ports (not shown in the drawing) for connecting to and communicating with peripheral devices, such as USB port, PS/2 port, serial port, parallel port, IEEE-1394 port, infra red communication port, etc., or other proprietary ports. The measurement modules may communicate with the data processing system via such signal input/output ports.

The embodiments of the present invention therefore provide improved methods and systems for damper system evaluation and tuning by employing a combination of a full vehicle model, a road description and a test rig with at least one physical damper system representing at least one corner of a real vehicle. Damper evaluation can occur without the need to gather road data with a full vehicle, allowing earlier testing than otherwise possible. The damper system components can be characterized under conditions which represent those that would occur on a road, without the need for either a real vehicle or a real road. Since the damper system components interact with the vehicle model through test rig feedback, changes in the damper system characteristics will result in changes in applied load, as will happen on a real road, thereby resulting in more realistic testing. The embodiments of the invention do not require reduction of damper system characteristics to engineering terms of an implied damper model, since a real damper with all of its un-modeled characteristics interacts with the modeled vehicle as it would with a real vehicle.

Although embodiments of the present invention have been described and illustrated in detail, the same is by way of illustration and example only and is not to be taken by way of limitation, the scope of the present invention being limited only by the terms of the appended claims.

What is claimed is:

1. A system for evaluating damper systems and vehicle performance, comprising:
at least one test rig on which at least one damper system under test is mountable, the test rig controllably imposing forces and motions on the damper system under test; and
a vehicle model module that includes:
a data processor for processing data; and
a data storage device configured to store: data related to a vehicle model that simulates a full vehicle except for characteristics of the damper system under test; data related to a road description; data related to at least one of maneuvers and driver behaviors, test rig parameters, controller parameters, test data; and machine-executable instructions, wherein the instructions, upon execution by the data processor, control the vehicle model module to produce command signals based on the vehicle model and the road description to control the test rig to apply loads on the damper system and to feed back measured responses of the test rig to the vehicle model.

2. The system of claim 1, further comprising a supervisor coupled to the vehicle model module and to the test rig, the supervisor comprising a data processor configured to coordinate the vehicle model and the test rig, provide the command signals to the test rig and provide the measured responses to the vehicle model.

3. The system of claim 1, wherein the human driver control component of the vehicle model is configured to operate open loop with respect to at least one of speed, course, position, behavior, or condition of the vehicle.

4. The system of claim 1, wherein the human driver control component of the vehicle model is configured to operate closed loop with respect to speed and a course of the vehicle.

5. The system of claim 1, wherein the full vehicle model includes modeling of: engine; powertrain, tires, vehicle dynamics, aerodynamics, driver and road.

6. The system of claim 5, wherein the full vehicle model includes models of damper systems that are not physically present in the test rig.

7. The system of claim 6, wherein the data processor is configured to model the full vehicle by a converging iterative process to virtually move the damper system under test to different positions on the vehicle model.

8. The system of claim 1, wherein the data related to the road description includes roadway surface definition including at least one of the parameters: coefficient of friction, roughness, slope, curvature, obstacle profiles, bump profiles, and temperature.

9. The system of claim 1, wherein the test rig includes a loading actuator that is controllable to axially displace the damper.

10. The system of claim 1, wherein the test rig includes a loading actuator that is controllable to axially load the damper.

11. The system of claim 9, wherein the test rig includes a plurality of the loading actuators, wherein each loading actuator is independently controllable.

12. The system of claim 1, wherein the test rig includes a moment input fixture controllable to input a moment on the damper system.

13. The system of claim 1, wherein the test rig includes a plurality of test stands.

14. The system of claim 2, wherein the supervisor and the vehicle model module are configured for coupling to different component test rigs for other vehicle components to interact with the different component test rigs and integrating in the vehicle model results from the different component test rigs and the test rig on which the damper system under test is mounted.

15. A method of evaluating damper systems and predicting vehicle performance, comprising:
mounting at least one damper component on at least one test rig;
modeling a vehicle model that is a full model excluding the damper system on the test rig;
determining state and motion of the modeled vehicle over a road;
generating command signals to the test rig based on the vehicle model and its state as at least one of displacement and load control signals;
applying at least one of displacements and loads to the damper system with the test rig in accordance with the command signals;
measuring at least one of resulting displacements and/or loads of the damper system at the test rig; and
providing at least one of the measured resulting displacements and/or loads to the vehicle model.

16. The method of claim 15, wherein the vehicle model is executed in real time.

17. The method of claim 15 wherein the damper system loads are provided to the test rig substantially synchronously with the model.

18. The method of claim 15, wherein a plurality of physical damper systems of a vehicle are mounted on at least on test rig and simultaneously evaluated.

19. The method of claim 15, further comprising simultaneously controlling a plurality of test rigs on which suspension components are mounted.

20. The method of claim 15, further comprising controlling inputs to test rigs on which are mounted physical vehicle components other than damper system, and receiving outputs from the test rigs and providing the outputs to the vehicle model.

21. The method of claim 15, further comprising subjecting the damper system to environmental conditions.

22. The method of claim 15, wherein the step of applying at least one of displacements and loads to the damper system with the test rig includes axially loading the damper system with a loading actuator.

23. The method of claim 20, wherein the test rig includes a plurality of the loading actuators, wherein each loading actuator is independently controllable to axially load the respective damper system.

24. The method of claim 15, wherein the step of applying at least one of displacements and loads to the damper system with the test rig includes inputting a moment on the suspension component with a moment input fixture.
